(19) United States
(12) Patent Application Publication
(10) Pub. No.: US 2010/0011411 A1
(43) Pub. Date: Jan. 14, 2010

(54) Policy-Based Usage of Computing Assets

(75) Inventors: Charles D. Bridgham, Cary, NC (US); Neeraj Agrawal, Cary, NC (US)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 12/172,038

(22) Filed: Jul. 11, 2008

(51) Int. Cl. G06F 21/00

(52) U.S. Cl. 726/1

(57) ABSTRACT

Policy is defined for usage of computing assets (including remote, or external, assets) in a computing environment. The policy may identify the assets by (for example) asset name, asset type, asset version, location in a repository, or some combination thereof. Policy definitions for remote assets are provided in a consistent manner. Policy for particular assets (for example) may vary from one role to another. Policy definitions are preferably used when initializing a computing environment, and also when subsequently importing an asset into that computing environment. The disclosed techniques may also, or alternatively, be used to ensure that a secure computing environment is created whereby only hardware and/or software in a policy can be installed into the computing environment.

### BACKGROUND OF THE INVENTION

The present invention relates to computing environments, and deals more particularly with using policy to control usage of computing assets (including remote, or external, assets) in a computing environment.

In large-scale software development projects, it is increasingly common for multiple teams to participate, where those teams are often in geographically-dispersed locations. Each team may have a number of team members such as software designers and developers (where these team members are referred to equivalently hereinafter as “developers” for ease of reference), and these team members may use any of a number of software development environments, and consumption of computing assets, to design and implement their respective code modules.

### BRIEF SUMMARY OF THE INVENTION

The present invention is directed to policy-based usage of computing assets. In one embodiment, this comprises: locating policy pertaining to a user of a computing environment, wherein the located policy specifies at least one of a plurality of computing assets which are allowed to be used by the user in the computing environment; resolving a location of each of the specified at least one computing asset; and automatically loading each of the at least one computing asset into the computing environment from the resolved location.

The locating, the resolving, and the automatically loading preferably occur automatically upon initializing the computing environment. The policy pertaining to the user is also preferably consulted, subsequent to initialization of the computing environment, upon each attempt to use a different one of the plurality of computing assets in the computing environment which is not yet loaded therein; and usage of the different one of the computing assets is preferably prevented if the different one is not allowed by the policy pertaining to the user.

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates, at a high level, interactions between entities in an existing software development environment;

FIGS. 2 and 3 illustrate sample policy documents, by way of illustration only;

FIGS. 4-6 provide flowcharts depicting how an embodiment of the present invention may be implemented;

FIG. 7 depicts a data processing system suitable for storing and/or executing program code; and

FIG. 8 depicts a representative networking environment in which one or more embodiments of the present invention may be used.

### DETAILED DESCRIPTION OF THE INVENTION

Embodiments of the present invention are directed toward policy-based usage of assets in a computing environment. Using techniques disclosed herein, policy definitions for computing assets (including remote, or external, assets) are provided in a consistent manner, and those policy definitions are preferably used when initializing a computing environment and also when subsequently importing an asset into that computing environment. The term “remote” assets is used herein, by way of illustration, to refer to the computing assets; “remote” refers generally to assets that are not locally stored at a team member's own computing environment. techniques disclosed herein do not actually depend on the location of the resources, however, and embodiments of the present invention may be used with locally-stored assets, remotely-stored assets, or a combination thereof. The disclosed techniques may also, or alternatively, be used to ensure that a secure computing environment is created whereby only hardware and/or software in a policy can be installed into the computing environment.

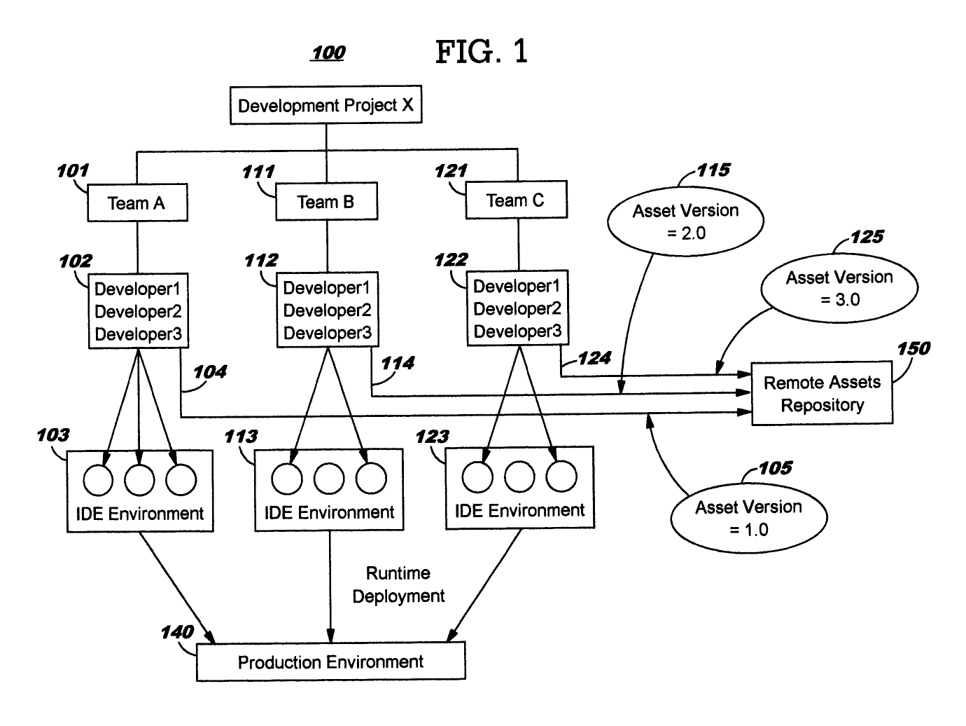

In large-scale software development projects, team members may use any of a number of software development environments to design and implement their respective code modules, as noted earlier. Different development environments may be used from one team to another, and even among the members of a single team. Interaction between entities in an existing software development environment will now be described with reference to the illustration in FIG. 1.

FIG. 1 illustrates a sample software development environment 100 for a project “X” where 3 teams “A”, “B”, and “C” are working together. See reference numbers 101, 111, 121. Each of these teams may be located a considerable distance from the others, and furthermore, the members of the individual teams may or may not be co-located. In the example, each of the teams is depicted as having 3 team members, and these team members are referred to in the figure as software developers. See reference numbers 102, 112, 122. (As will be obvious, a large-scale development effort may include team members in other roles, such as testers, although those other roles are not illustrated in FIG. 1. References herein to team members in various roles should be construed as illustrative but not limiting.)

In a multi-person software development effort, various techniques are used to control usage of remote assets (referred to alternatively herein as “external assets”). “Asset”, in this context, refers to a reusable software component. Such components may be stored in a centralized remote assets repository. See reference number 150.

In the environment illustrated in FIG. 1, each of the teams uses a so-called “IDE” for software development. See reference numbers 103, 113, 123. The term “IDE” is an acronym for Integrated Development Environment. An IDE is a software application package that provides various tools to support the development process. Commonly, an IDE includes facilities for editing source code, compiling and/or interpreting source code, building executables from a collection of modules, and testing/debugging the executable code. An IDE that supports object-oriented programming may include other features such as a class browser, class hierarchy viewer, and so forth. (An embodiment of the present invention is not limited to use with a particular IDE or to use with an IDE environment per se; more generally, an embodiment of the present invention may be used with a developer's workspace of one form or another, and thus references to a developer's IDE should be construed as referring alternatively to other types of developer workspaces.)

The teams may access remote assets repository 150 through a network. This is illustrated generally by reference numbers 104, 114, 124. For example, a member of Team A may retrieve a copy of version 1.0 of a particular asset from repository 150, as noted as reference number 105. The team member may alter this copy within IDE 103, and might then integrate that altered copy with other assets that will then be tested within IDE 103 by members of Team A. As the teams progress on their respective contributions to the software project, those contributions may be aggregated and deployed to a run-time or production environment. See reference number 140.

The complexity of a multi-person software development effort increases significantly when more than a small number of developers are involved. Team A, for example, might work smoothly as long as all of its developers use the same version of a particular asset. However, if Team A uses version 1.0 of this asset, but Team B uses version 2.0 of that same asset (as depicted at reference number 115), this mismatch between the versions may prevent the development project from functioning correctly when the work of Team A is to be integrated with the work of Team B for use in production environment 140. FIG. 1 further illustrates a scenario where Team C uses yet another version, namely version 3.0 in this example, of the same asset from the remote repository 150; see reference number 125. Considerable time and expense may be wasted as a result of this mismatch among the versions of the remote asset.

Existing approaches to usage of remote assets include IDE preferences and configuration files. As an example of using IDE preferences, an IDE might provide a preferences menu, for example, that allows an individual developer to select which of several available third-party tools that developer wishes to use with particular assets from a repository. As each member of the development team sets his or her own preferences, inconsistencies in remote asset usage may arise if different third-party tools are in use among the team members. Configuration files may specify preferences in a similar manner, where each developer may have different information in her or her configuration file, leading to the same type of inconsistencies.

Usage of remote assets may be further complicated due to inconsistent asset resolution interfaces or techniques. For example, there may be a number of mechanisms in use among the development team members for using assets of different types. Suppose a particular asset is provided by a third-party provider. A proprietary or provider-specific interface may be required for working with that asset. If an alternative implementation of that asset is also available from a different third party, it may happen that the interface for that alternative is completely different. The first provider might make the asset available from a container residing on a remote server, for example, where that container is accessed using a proxy, while the other provider's approach is to deliver a binary form of the asset for local storage directly on the developer's computing device. If developers must maintain an awareness of such differences, developer productivity may be reduced and likeliness of errors may increase.

Furthermore, no automated mechanism is known to the present inventors for ensuring that all team members are using the same version of the remote assets. In a small team, it may be sufficient for team members to verbally communicate which versions of which assets they are working with; however, this approach quickly becomes untenable as the size of the development effort grows.

An embodiment of the present invention uses a policy-based approach for remote asset usage. Preferably, this policy is applied using a centralized, organization-wide approach. Techniques are disclosed herein for defining the policy for the remote assets in a consistent manner, as well as for using the policy to enforce usage of those remote assets according to the definitions in the policy.

A policy definition (“PD”) engine is disclosed, according to an embodiment of the present invention. Standardizing a definition of the remote assets in the policy enables creating policies for usage of remote assets that is independent of which IDE may be in use in a particular computing environment. A policy enforcement (“PE”) engine is also disclosed, according to an embodiment of the present invention, and this PE engine preferably takes, as its input, policy created using the PD engine. In addition, the PE engine preferably sets up a developer's development environment according to the policy definition upon initialization of the environment and validates subsequent imports of remote assets into that development environment. The PE engine therefore enforces usage of the remote assets according to the defined policy.

Policies may be based on roles, remote repository information, and/or asset description, by way of example. Different policies may be defined, for example, for people working in different roles. A policy for people working in an integrator role, for example, might allow usage of a subset of the assets from the repository, such as assets which have already been created and compiled into executable form. These assets might be identified in the policy using an asset description such as their file type, as one example. As one alternative approach, the assets might be identified in the policy by specifying their location within a particular file structure at the remote asset repository. In yet another approach, a policy might specify a selected repository from which the assets must be retrieved. As yet a further approach, a combination of these types of information may be used to identify the remote assets within a policy.

Notably, although FIG. 1 shows a single remote asset repository 160, this is by way of illustration only. In an actual development environment, assets might reside in a number of repositories, and redundant copies of the assets might be provided (for example, to achieve load balancing or otherwise improve performance). An embodiment of the present invention may be used to ensure that inconsistencies among the redundant copies of an asset are avoided, and policy may specify which one(s) of the redundant copies are to be used.

In addition to identifying remote assets within a policy for controlling remote asset usage, the policy might specify certain permissions—such as read-only access—that are to be enforced for the asset. Permissions for using a particular asset may vary from one role to another, as defined in the policy.

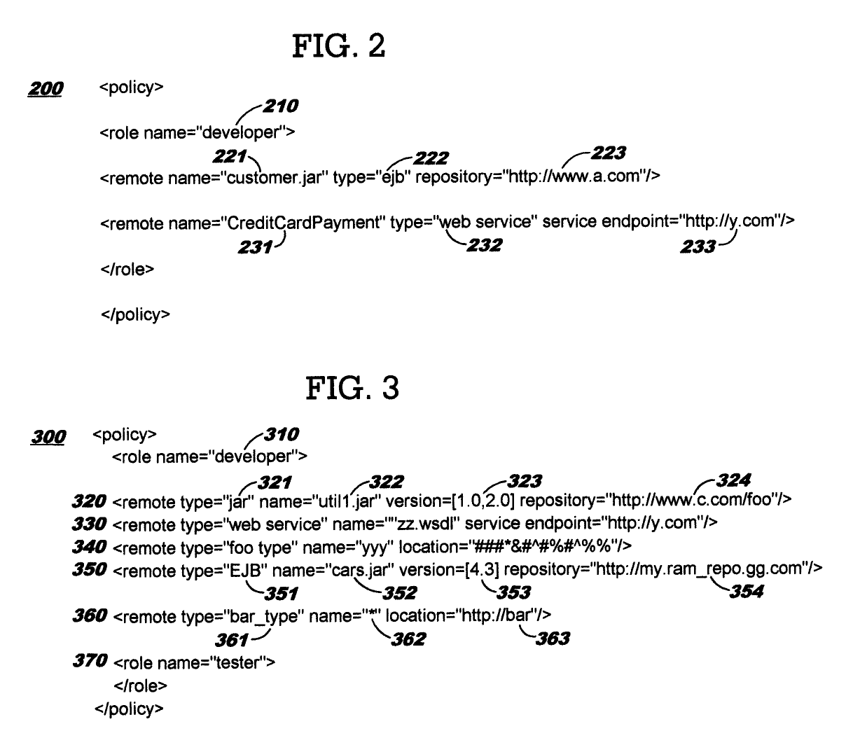

A policy may be expressed using a markup language document, such as an XML (Extensible Markup Language) document. In one approach, a single XML document may be used as a “master”, organization-wide policy, where this document has different sections that define different roles. Attributes may be defined within the XML policy document to specify applicability of the roles defined in the various sections of this master policy. (See, for example, the “name” attribute 210 on the “<role>” element in document 200 of FIG. 2.) In another approach, a separate policy document may be defined for each different role in the policy. Attributes may also be used in the policy document for specifying the policy applicability to various roles when using this approach. Policy documents are further discussed below, with reference to examples depicted in FIGS. 2 and 3.

One policy might be used for all members of a particular team, for example, or for all members having a particular role. Preferably, a policy defines which assets are to be used according to that policy by specifying at least one of the asset name, asset type, asset version, and asset location (e.g., as a remote asset repository location); in an alternative approach, other identifying characteristics may be used. Referring now to FIGS. 2 and 3, sample policy definitions will be discussed in more detail.

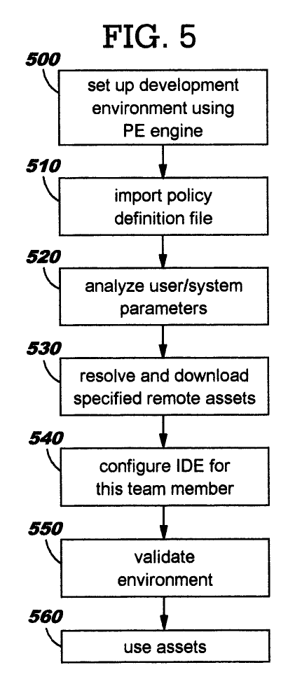

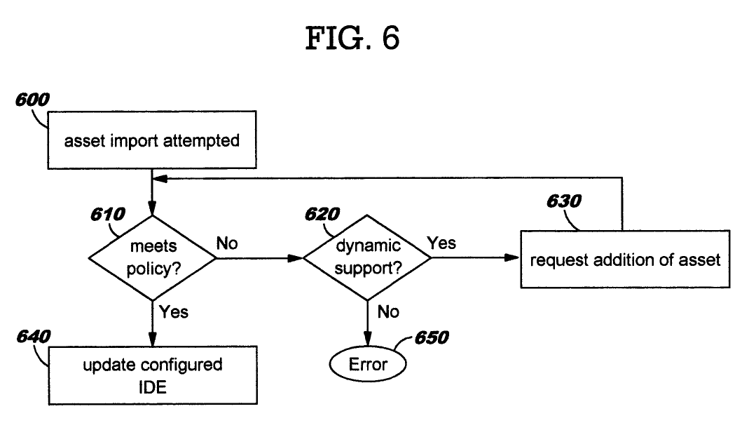

Referring first to FIG. 2, the sample policy 200 illustrated therein defines a policy for a role of “developer”. See reference number 210. In this example, remote assets of two types are specified, namely asset types of “ejb” and “web service”. See reference numbers 222 and 232, respectively. This sample policy illustrates use of remote assets from multiple asset repositories. When the PE engine processes this policy 200 during initialization of the developer's computing environment (as further discussed below with reference to FIG. 5), it will preferably automatically load the developer's environment with an EJB named “customer.jar” (see reference number 221) from a remote repository that is accessible using the Uniform Resource Locator (“URL”) specified at reference number 223 and with a web service named “CreditCardPayment” (see reference number 231) having a service endpoint that is accessible using the URL specified at reference number 233. This policy 200 may also be used when the developer subsequently requests to import an asset into an already-initialized computing environment, in which case the PE engine preferably uses this policy 200 to determine whether that import can occur (i.e., whether the asset to be imported conforms to the developer's policy), as further discussed below with reference to FIG. 6.

By way of example, types of remote assets that may be specified in policy definitions include (but are not limited to) web services, .jar files, EJBs, and/or user-defined remote asset types. An asset resolver function is preferably provided with an embodiment of the present invention for resolving locations of one or more predefined asset types. Technology-specific considerations may be addressed in these asset resolvers, such as resolving a web service endpoint or selecting a jar file. Techniques for resolving such assets are known in the art, and do not form part of the inventive concepts of the present invention. User-defined types may be supported with an embodiment of the present invention by plugging an asset resolver into the IDE and configuring this asset resolver as needed (for example, by updating a mapping to identify the code of this asset resolver in association with the user-defined asset type, such that the asset resolver will be invoked for resolving such user-defined asset type).

FIG. 3 provides another sample policy document 300. In this example, an alternative policy for the role of “developer” is defined. See reference number 310. In this example, remote assets of five different types are specified for this role. See the “type” attribute in <remote> elements 320, 330, 340, 350, 360. While the example shown in FIG. 2 is relatively simple, syntax variations that may be supported by an embodiment of the present invention are illustrated in FIG. 3, as will now be discussed.

The “version” attribute 323 illustrates a syntax whereby the policy specifies a range of allowable versions. In this example, when the PE engine processes policy document 300 and loads the developer's environment with assets according to this policy, it will load any assets named “util1.jar” (see reference number 322) that have a type of “jar” (see reference number 321), and which are stored in a remote repository that is accessible using the URL specified at reference number 324, and which also have a version number that falls in the range of 1.0 through 2.0 (see reference number 323).

Another example of using a “version” attribute is shown at reference number 353. In this example, a single version number of 4.3 is specified, and the PE engine will then load an asset of the specified type 351 with the specified name 352 from the specified URL 354 only if the version number of the asset matches the version number specified at 353.

Optionally, an embodiment of the present invention may support a wildcard feature. This is illustrated by element 360, where an “*” is specified as the asset name. See reference number 362. When processing this policy 300, the PE engine will load any asset of type “bar_type” (see reference number 361) that is stored at the specified URL 363, without regard to the name of that asset (because all names would be considered as matching the wildcard 362).

The policy syntax shown in FIGS. 2 and 3 is provided by way of illustration but not of limitation, and other policy syntax may be supported without deviating from the scope of the present invention. When policy for more than one role is specified within a single XML policy document, an additional <role> element may be added within the <policy> element for each such role. This is illustrated in FIG. 3 for a “tester” role; see reference number 370.

A policy definition for a large project may be quite complex, and the policy document may therefore contain many more definitions than the simple examples used herein for illustration. Using an XML document (or documents, when more than one XML document is used) to embody the policy definition makes the policy independent of the development environment where it will be deployed, as noted earlier. As a result, policies as disclosed herein may be imported and enforced in many different environments. Those environments include (by way of example) an Eclipse, NetBeans, or other Java-based IDE. Policies may alternatively (or additionally) be used in a non-Java-based IDE; when the PD engine is used to define policy for a non-Java environment, an adapter is preferably provided to support that environment in the PE engine. In preferred embodiments, the PD engine is implemented in a language chosen by the enterprise where the PD engine will be deployed (although the policy definition is technology-agnostic).

An embodiment of the present invention may support static policy and dynamic policy. When using a static policy, the defined policy specifications are processed by the PE engine, and remote asset usage is controlled accordingly for the assets defined in that policy. If assets are subsequently added to a remote asset repository but those assets do not meet the usage criteria specified in any policy definition, then those assets are essentially unusable during development (i.e., until such time as the policy may be revised to include those assets).

By contrast, when a dynamic policy is supported, the addition of assets to a remote asset repository preferably automatically triggers a corresponding addition to the policy definition. In this latter case, addition of the new asset preferably causes the PD engine to automatically create an entry in the policy file that will match this new asset. For example, the asset name and type may be programmatically determined, and an XML element may be programmatically constructed in the policy file that includes attribute name/value pairs to record that information. As an alternative approach, the developer adding the asset may ask a person with administrative authority to update the policy using the PD engine. As yet another alternative, an automatic request may be generated and sent to a person with administrative authority to request an update to the policy to thereby account for the added asset.

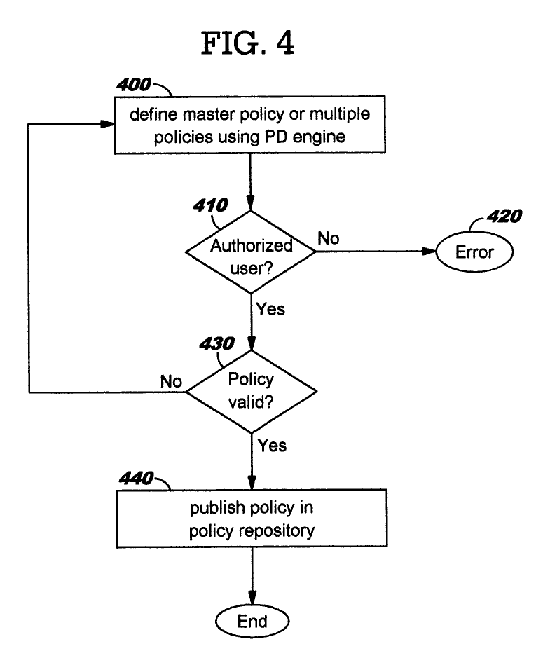

Turning now to FIGS. 4-6, flowcharts are provided depicting how an embodiment of the present invention may be implemented. Each of the figures will now be discussed.

As shown at Block 400 of FIG. 4, a master policy document or multiple policy documents is/are created using the PD engine as disclosed herein. A policy document may be created, for example, by a project architect. Preferably, creation of policy documents (as well as subsequent updates thereto) for static policy is limited to persons with administrative authority. Block 410 tests whether this person is an authorized user for creating policy documents. If not, then this is an error (Block 420) and the policy document is not accepted. If the user is authorized, then processing continues at Block 430, which tests whether the policy is valid. Various syntactic checks may be performed; semantic checks may also be performed at Block 430. Such checks may vary, depending upon the particular syntax which is adopted for specifying the policy. If the test at Block 430 has a negative result, then control preferably returns to Block 400 to enable correcting any errors. Otherwise, control reaches Block 440, where this policy is published. Preferably, this publishing comprises storing the policy in a centralized policy repository.

As discussed earlier, dynamic policy may be supported by an embodiment of the present invention. In that case, the processing preferably occurs in a similar manner to that shown in FIG. 4 with the exception of the verification of the user's authority. That is, dynamic policy updates are preferably not limited to persons with administrative authority. Administrative authority may be required for publishing policy updates to the team members, however.

Referring now to FIG. 5, actions that may be performed when initializing a development environment according to an embodiment of the present invention are illustrated. A team member such as a developer sets up his development environment using the PE engine (Block 500). According to preferred embodiments, the PD and PE engines are part of every team member's development environment. In an Eclipse-based environment, by way of example, this may comprise a set of plug-ins that are mandatorily present in every team member's development installation.

In an alternative embodiment, the PE engine is part of every team member's environment, and the PD engine is installed for those team members who are authorized to define policy.

As the development environment is initialized, an action is preferably triggered to import the policy definition file from the centralized repository (Block 510). User and system parameters may be taken into account when processing the imported policy, and such parameters are first analyzed (Block 520). For example, the team member's role may be programmatically determined and used to locate the role-specific policy statements within the policy file. The IDE for a particular user might be limited to the capabilities pertaining to that developer's job responsibilities. For example, a Web developer might not have capabilities for business logic creation or for database manipulation. As another example, of use of parameters, the developer's execution environment may be determined (such as what operating system is in use), and this information may impact which policy statements are applied from the policy file. Based on the policy file, as impacted by the analyzed parameters, the PE engine automatically resolves and downloads the remote assets as defined in the policy for that team member (Block 530). Note that the various remote assets may reside in potentially disparate asset repositories. The definition specified in the policy for this team member enables automatically locating and obtaining the specific remote assets that this team member is required to use. The team member's IDE (or, more generally, the team member's workspace) is configured for using the downloaded assets (Block 540). Configuring the PE engine may comprise, by way of example, invoking various asset resolvers to make the assets usable in the team member's IDE. For example, configuring a Web service may comprise invoking an asset resolver for the Web service to create stubs, and configuring a Web service for an asset type of jar may comprise adding the jar file to the class path for this IDE. The PE engine may then perform a validation of the team member's development environment (Block 550) to ensure that all presently-loaded assets conform to the policy for this team member, and if not, may prevent use of those non-conforming assets within this development environment (not shown in FIG. 5). That is, the team member is not allowed to use these non-conforming assets, according to the policy. When the validation is successful, the team member may then proceed to use selected ones of the assets (Block 560) for product development.

FIG. 6 illustrates actions that may occur when a team member is interacting with an already-initialized development environment. An attempt is made to import an asset into this team member's development environment (Block 600). In response, the PE engine automatically invokes a validation to determine whether the asset meets the policy currently defined for this team member (Block 610). When the validation performed at Block 610 has a positive result, the configured IDE is updated to include the imported asset (Block 640). If the asset does not meet the policy, on the other hand, then Block 620 represents determining whether this implementation supports dynamic policy. If it does not, then an error is generated (Block 650) and the asset is not imported (and therefore is not usable by the team member). When the test at Block 620 has a positive result, on the other hand, control reaches Block 630, representing a potential dynamic addition of the asset to the policy (for example, by sending a message to someone with administrative authority to request adding the asset). Processing is shown in FIG. 6 as returning to the validation at Block 610 following Block 630, such that the asset may be re-validated (and as will be obvious, some time may pass before this re-validation actually occurs, to include time for updated policy to be published to the team member's computing environment). The processing shown in FIG. 6 may iterate for each asset to be imported; as one alternative, the processing shown in FIG. 6 may be applied to more than one asset on each iteration.

While embodiments of the present invention have been discussed above with regard to defining and enforcing policy for remote asset usage in a software development environment, these techniques may also (or alternatively) be adapted for creating a secure computer system or environment where only the devices and/or software defined in the policy can be installed in this secure computer system/environment. In this case, the policy document created with the PD engine defines the installable devices/software, and the PE engine enforces that policy during installation of a device or software. Accordingly, the processing in FIG. 4 may be adapted for specifying this alternative type of policy information; the processing in FIG. 5 may be adapted for the initial installation of hardware and/or software; and the processing in FIG. 6 may be adapted to determine whether a device or software can be subsequently installed into that computer system/environment.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

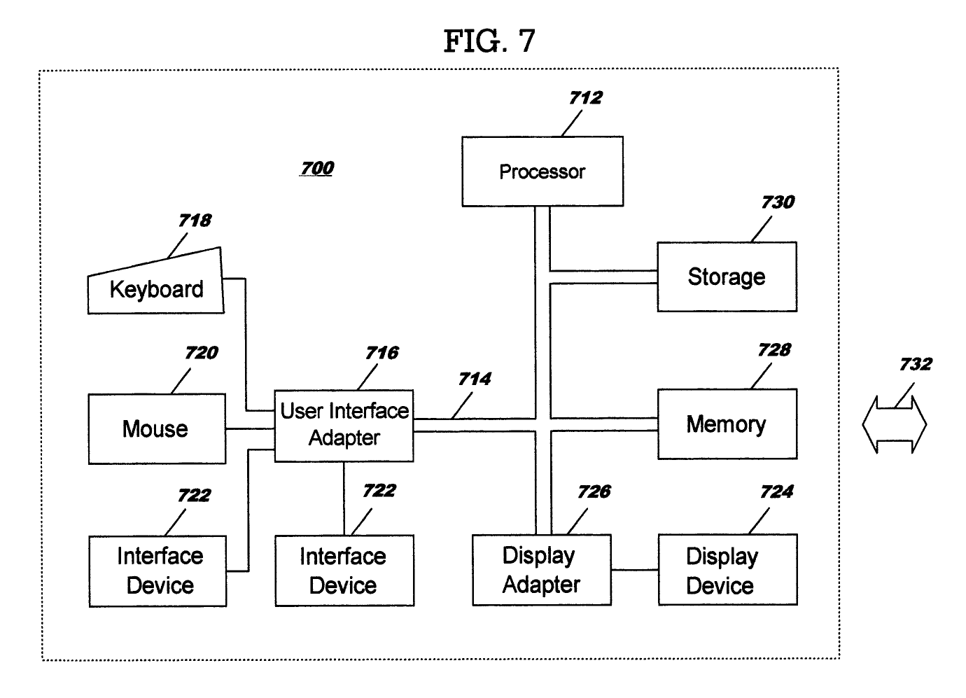

Referring now to FIG. 7, a data processing system 700 suitable for storing and/or executing program code includes at least one processor 712 coupled directly or indirectly to memory elements through a system bus 714. The memory elements can include local memory 728 employed during actual execution of the program code, bulk storage 730, and cache memories (not shown) which provide temporary storage of at least some program code in order to reduce the number of times code must be retrieved from bulk storage during execution.

Input/output (“I/O”) devices (including but not limited to keyboards 718, displays 724, pointing devices 720, other interface devices 722, etc.) can be coupled to the system either directly or through intervening I/O controllers or adapters (716, 726).

Network adapters may also be coupled to the system to enable the data processing system to become coupled to other data processing systems or remote printers or storage devices through intervening private or public networks (as shown generally at 732). Modems, cable modem attachments, wireless adapters, and Ethernet cards are just a few of the currently-available types of network adapters.

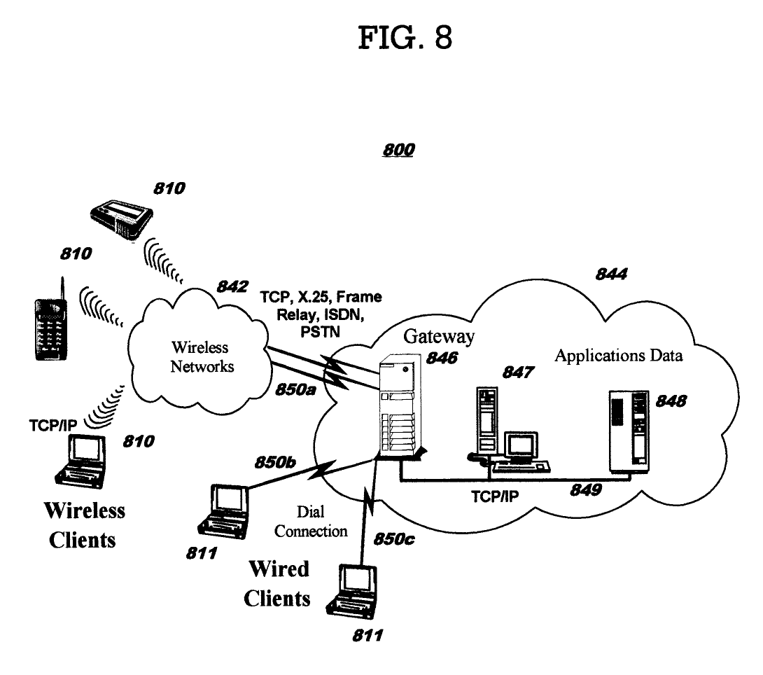

FIG. 8 illustrates a data processing network environment 800 in which the present invention may be practiced. The data processing network 800 may include a plurality of individual networks, such as wireless network 842 and wired network 844. A plurality of wireless devices 810 may communicate over wireless network 842, and a plurality of wired devices, shown in the figure (by way of illustration) as workstations 811, may communicate over wired network 844. Additionally, as those skilled in the art will appreciate, one or more local area networks (“LANs”) may be included (not shown), where a LAN may comprise a plurality of devices coupled to a host processor.

Still referring to FIG. 8, the networks 842 and 844 may also include mainframe computers or servers, such as a gateway computer 846 or application server 847 (which may access a data repository 848). A gateway computer 846 serves as a point of entry into each network, such as network 844. The gateway 846 may be preferably coupled to another network 842 by means of a communications link 850a. The gateway 846 may also be directly coupled to one or more workstations 811 using a communications link 850b, 850c, and/or may be indirectly coupled to such devices. The gateway computer 846 may be implemented utilizing an Enterprise Systems Architecture/390® computer available from IBM. Depending on the application, a midrange computer, such as an Application System/400® (also known as an AS/400®), iSeries®, System i™, and so forth may be employed. (“Enterprise Systems Architecture/390”, “Application System/400”, “AS/400”, and “iSeries” are registered trademarks of IBM in the United States, other countries, or both, and “System i” is a trademark of IBM.)

The gateway computer 846 may also be coupled 849 to a storage device (such as data repository 848).

Those skilled in the art will appreciate that the gateway computer 846 may be located a great geographic distance from the network 842, and similarly, the wireless devices 810 and/or workstations 811 may be located some distance from the networks 842 and 844, respectively. For example, the network 842 may be located in California, while the gateway 846 may be located in Texas, and one or more of the workstations 811 may be located in Florida. The wireless devices 810 may connect to the wireless network 842 using a networking protocol such as the Transmission Control Protocol/Internet Protocol (“TCP/IP”) over a number of alternative connection media, such as cellular phone, radio frequency networks, satellite networks, etc. The wireless network 842 preferably connects to the gateway 846 using a network connection 850a such as TCP or User Datagram Protocol (“UDP”) over IP, X.25, Frame Relay, Integrated Services Digital Network (“ISDN”), Public Switched Telephone Network (“PSTN”), etc. The workstations 811 may connect directly to the gateway 846 using dial connections 850b or 850c. Further, the wireless network 842 and network 844 may connect to one or more other networks (not shown), in an analogous manner to that depicted in FIG. 8.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method for policy-based usage of computing assets, comprising:
locating policy pertaining to a user of a computing environment, wherein the located policy specifies at least one of a plurality of computing assets which are allowed to be used by the user in the computing environment;
resolving a location of each of the specified at least one computing asset; and
automatically loading each of the at least one computing asset into the computing environment from the resolved location.

2. The method according to claim 1, wherein the locating, the resolving, and the automatically loading occur automatically upon initializing the computing environment.

3. The method according to claim 1, wherein:
the policy pertaining to the user is consulted, subsequent to initialization of the computing environment, upon each attempt to use a different one of the plurality of computing assets in the computing environment which is not yet loaded therein; and
usage of the different one of the computing assets is prevented if the different one is not allowed by the policy pertaining to the user.

4. The method according to claim 1, wherein a policy enforcement engine performs the locating and performs the automatically loading, using output from an asset resolver which performs the resolving, and wherein the policy enforcement engine is configured into the computing environment as a required element thereof.

5. The method according to claim 1, wherein the policy specifies the location of each of the at least one computing asset.

6. The method according to claim 1, wherein the policy identifies at least one of the at least one computing asset by specifying a name thereof.

7. The method according to claim 1, wherein the policy identifies at least one of the at least one computing asset by specifying a type thereof.

8. The method according to claim 1, wherein the policy identifies at least one of the at least one computing asset by specifying an allowable version thereof.

9. The method according to claim 1, wherein the located policy is located using a role of the user to find policy applicable to that role.

10. The method according to claim 1, wherein the policy identifies at least one of the at least one computing asset by specifying a name, a type, an allowable version, and a location thereof.

11. The method according to claim 10, wherein a wildcard is specified in the policy for at least one of the specified name, type, allowable version, or location.

12. The method according to claim 1, wherein the policy is defined using a policy definition engine that is configured into the computing environment as a required element thereof.

13. The method according to claim 1, wherein the policy is defined using a markup language document.

14. The method according to claim 13, wherein the markup language document specifies policy for a single user.

15. The method according to claim 13, wherein the markup language document comprises a plurality of portions, each specifying policy for one of a plurality of user roles.

16. The method according to claim 15, wherein the markup language document comprises attribute values indicating which of the portions applies to different ones of the user roles.

17. A system for policy-based usage of computing assets, comprising:
a computer comprising a processor; and
instructions executable using the processor to implement functions comprising:
locating policy pertaining to a user of a computing environment, wherein the located policy specifies at least one of a plurality of computing assets which are allowed to be used by the user in the computing environment;
resolving a location of each of the specified at least one computing asset; and
automatically loading each of the at least one computing asset into the computing environment from the resolved location.

18. The system according to claim 17, wherein:
the instructions for locating, resolving, and automatically loading are executed automatically upon initializing the computing environment; and
further comprising instructions executable using the processor to implement functions comprising:
consulting the policy pertaining to the user, subsequent to initialization of the computing environment, upon each attempt to use a different one of the plurality of computing assets in the computing environment which is not yet loaded therein; and
preventing usage of the different one of the computing assets if the different one is not allowed by the policy pertaining to the user.

19. A computer program product for policy-based usage of computing assets, the computer program product embodied on at least one computer-readable medium and comprising computer-readable program code for:
locating policy pertaining to a user of a computing environment, wherein the located policy specifies at least one of a plurality of computing assets which are allowed to be used by the user in the computing environment;
resolving a location of each of the specified at least one computing asset; and
automatically loading each of the at least one computing asset into the computing environment from the resolved location.

20. The computer program product according to claim 19, wherein:
the computer-readable program code for locating, resolving, and automatically loading is executed automatically upon initializing the computing environment; and
further comprising computer-readable program code for:
consulting the policy pertaining to the user, subsequent to initialization of the computing environment, upon each attempt to use a different one of the plurality of computing assets in the computing environment which is not yet loaded therein; and
preventing usage of the different one of the computing assets if the different one is not allowed by the policy pertaining to the user.
